(19) United States
(12) Patent Application Publication
(10) Pub. No.: US 2008/0196372 A1
(43) Pub. Date: Aug. 21, 2008

(54) Cutting Unit with Moveable Groomer

(75) Inventors: Kenneth R. Wilson, Stanley, NC (US); Jonathan Maturan, Charlotte, NC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 12/033,246

(22) Filed: Feb. 19, 2008

Related U.S. Application Data
(60) Provisional application No. 60/890,718, filed on Feb. 20, 2007.

(51) Int. Cl. A01D 34/42

(52) U.S. Cl. 56/10.1; 56/251

(57) ABSTRACT

A turf cutting unit includes a reel assembly having a plurality of blades rotatable relative to the ground. A groomer includes a plurality of spaced apart and vertically oriented cutting plates fixed to a driven shaft. The groomer is moveable between a first position where the cutting plates engage the turf and a second position where the cutting plates are spaced apart from the turf. A method of operating a turf cutting unit is also described.

### CROSS-REFERENCE TO RELATED APPLICATIONS

This application claims the benefit of U.S. Provisional Application No. 60/890,718, filed on Feb. 20, 2007. The disclosure of the above application is incorporated herein by reference.

### FIELD

The present disclosure relates to a mower and to a cutting unit having a moveable groomer.

### BACKGROUND

The statements in this section merely provide background information related to the present disclosure and may not constitute prior art.

Grass cutting units having rotatable powered cutting reels and powered grooming reels or groomers may be useful to generate vertical growth and thicken the turf while cutting the grass. To maintain a desired quality of cut, the cutting blades of the reel assembly require periodic sharpening. Due to the close proximity of the groomer to the cutting reel, clearance for reel cylinder grinding equipment is typically not provided when the groomer is in a position engaging the turf. In the past, the cutting unit was at least partially disassembled to remove the groomer and provide clearance for the blade sharpening apparatus. After blade sharpening, the groomer would be reinstalled and a height adjustment for the groomer would subsequently have to be made.

The removal, re-installation and adjustment process of the groomer is costly and time consuming. Accordingly, it may be desirable to provide a cutting unit having a groomer that may be selectively moved between operating and retracted positions where blade sharpening machinery has access to the cutting blades when the groomer is in the retracted position. Furthermore, it may be desirable to selectively operate the cutting unit with the groomer at a set operating height for engagement with the turf and alternatively with the groomer at its retracted position when a grooming operation is not desired.

### SUMMARY

The present disclosure provides a turf cutting unit including a reel assembly having a plurality of blades rotatable relative to the ground. A groomer includes a plurality of spaced apart and vertically oriented cutting plates fixed to a driven shaft. The groomer is moveable between a first position where the cutting plates engage the turf and a second position where the cutting plates are spaced apart from the turf.

Additionally, a turf cutting unit includes a reel assembly mounted to a frame and having a plurality of blades rotatable about a reel axis extending substantially parallel to the ground. A groomer includes a plurality of spaced apart and substantially vertically oriented cutting plates fixed to a driven shaft. A groomer adjustment mechanism is operable in a first mode to move the groomer between a first position where the cutting plates engage the turf a predetermined amount and a second position where the cutting plates are spaced apart from the turf. The groomer adjustment mechanism is operable in a second mode to adjust the position of the cutting plates to vary the amount the cutting plates engage the turf when the groomer is in the first position.

A method of operating a turf unit including a reel blade assembly and a groomer having cutting plates is also disclosed. The method includes moving a first member relative to a second member to place the groomer at a first position and set a depth of penetration of the cutting plates. Relative movement between the first and second members is restricted. The first and second members are moved as a unit relative to a third member to move the groomer from the first position to a second position clear of the turf. The groomer is returned to the first position by moving the first and second members relative to the third member. The first and second members are restricted from movement relative to the third member to maintain the groomer at the first position.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a riding mower equipped with a cutting unit having a moveable groomer;

FIG. 2 is a perspective view of a cutting unit according to the teachings of the present disclosure;

FIG. 3 is a side view of the cutting unit shown in FIG. 2;

FIG. 4 is a partial perspective view of the cutting unit shown in FIG. 2;

FIG. 5 is a perspective view of a left hand adjustment assembly of the cutting unit shown in FIG. 2;

FIG. 6 is another perspective view of the adjustment assembly shown in FIG. 5;

FIG. 7 is a partial exploded perspective view of the adjustment assembly shown in FIGS. 5 and 6;

FIG. 8 is another partial exploded perspective view of the adjustment assembly shown in FIGS. 5-7;

FIG. 9 is a partial exploded perspective view of a drive mechanism for a groomer of the cutting unit shown in FIG. 2; and

FIG. 10 is another partial exploded perspective view showing the drive mechanism for the groomer.

### DETAILED DESCRIPTION

The following description is merely exemplary in nature and is not intended to limit the present disclosure, application, or uses. It should be understood that throughout the drawings, corresponding reference numerals indicate like or corresponding parts and features.

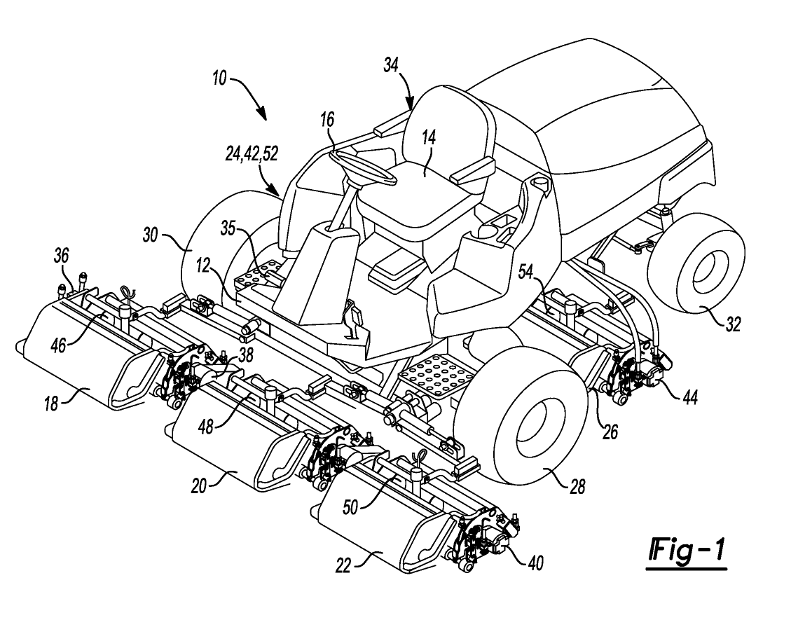

FIG. 1 depicts a riding mower assembly 10 including a frame 12 supporting a seat 14 operable to support a passenger, a steering device 16 such as a steering wheel, and a plurality of cutting units 18, 20, 22, 24 and 26 (fourth cutting unit 24 is not clearly visible in this view). Front wheels 28, 30 and rear wheels 32, 34 are rotatably connected to frame 12 and used to propel or steer riding mower assembly 10. A power unit (not shown) is connected to and supported by frame 12. The power unit provides power to rotate one or more of the wheels 28, 30, 32, 34. In various embodiment, the power unit may supply power to electric motors to drive various wheels, may provide power to a hydraulic pump outputting pressurized hydraulic fluid, or may provide mechanical energy to otherwise directly or indirectly drive the various wheels. The pressurized hydraulic fluid operates hydraulic motors at the driven wheels. A speed control device 35, such as a foot controlled pedal, is provided to control a forward or reverse speed of mower assembly 10. While mower assembly 10 in described herein in various embodiments as a riding mower, one skilled in the art will recognize that other embodiments could include a walking mower, a stand-behind mower, and a riding mower.

The power unit is also coupled to a plurality of motors 36, 38, 40, 42, 44, each connected to one of the plurality of first through fifth cutting units 18, 20, 22, 24 and 26 (fourth motor 42 is not visible). In various embodiments, the power unit may provide electrical energy to electric motors or alternatively may provide pressurized hydraulic fluid to hydraulic motors to provide the rotating drive force to operate a plurality of first through fifth reel blade assemblies 46, 48, 50, 52, 54 rotatably mounted to individual first through fifth cutting units (fourth reel blade assembly 52 is not visible).

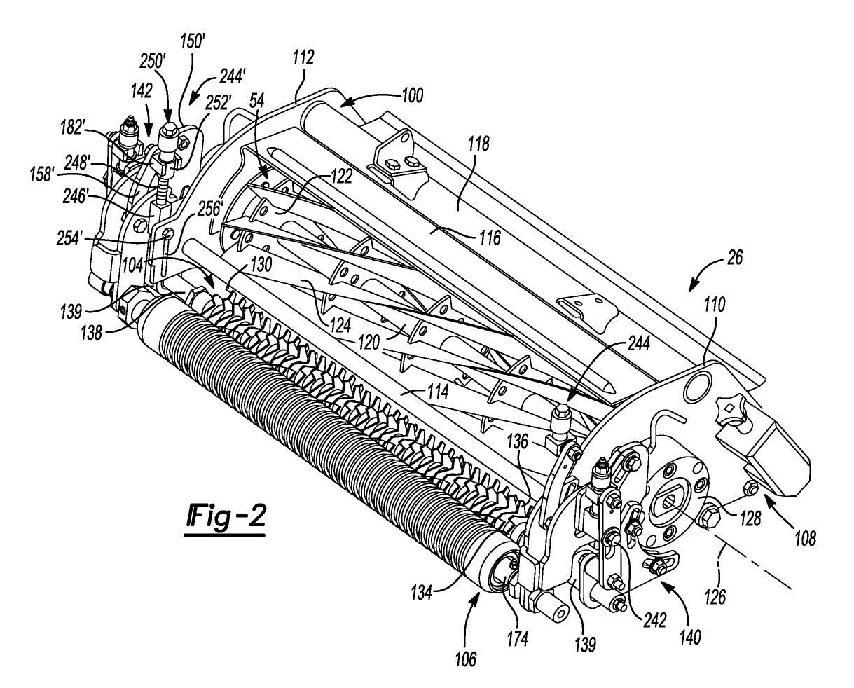

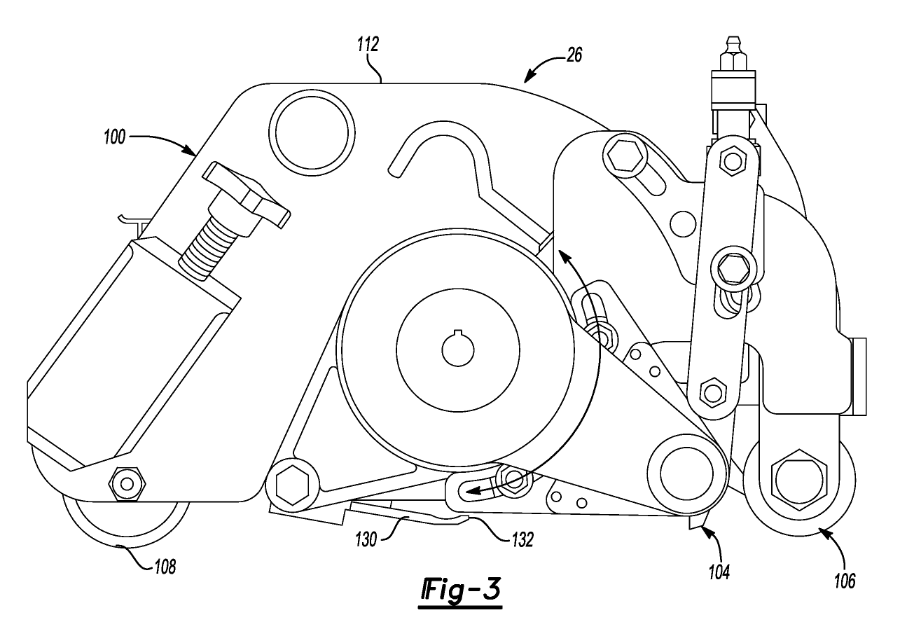

FIGS. 2-4 depict cutting unit 26 in greater detail. Cutting unit 26 includes a reel housing 100 rotatably supporting cutting reel assembly 54, a groomer 104, a front roller 106 and a rear roller 108. Reel housing 100 includes a left plate 110 and a right plate 112 each being vertically oriented relative to the ground and positioned substantially parallel to one another. A first cross-member 114, a second cross-member 116 and a third cross-member 118 interconnect left plate 110 and right plate 112.

Reel assembly 54 includes a central shaft or tube 120 and a plurality of substantially planar blade supports 122 spaced apart from one another and mounted to tube 120. A plurality of reel blades 124 are circumferentially spaced apart from one another and fixed to blade supports 122. Each reel blade 124 has a helical shape. Reel assembly 54 is rotatable about an axis 126. Hydraulic motor 44 is fixed to a hydraulic motor mount 128 and is operable to drive reel assembly 54 in rotation about axis 126. A bed knife 130 is coupled to reel housing 100. A cutting edge 132 of bed knife 130 is placed in close proximity to reel assembly 54 to perform a grass cutting operation.

Groomer 104 includes a plurality of cutting plates 134 vertically oriented relative to the ground and spaced apart from one another. Each cutting plate 134 includes a plurality of circumferentially spaced apart teeth 136. Teeth 136 are operable to cut runners and stolons of the turf to generate growth points and thicken the turf. Groomer 104 further functions to keep the grass growing in a vertical direction instead of a horizontal direction. Cutting plates 134 are fixed to a driveshaft 138. Bearing assemblies 139 rotatably support driveshaft 138. Driveshaft 138 is in driving communication with the power source as will be described in detail.

A left front adjustment assembly 140 operates in conjunction with a right front adjustment assembly 142 to rotatably support front roller 106 and groomer 104 on reel housing 100. Adjustment assemblies 140 and 142 are operable to set a cutting height for reel assembly 54. The position of groomer 104 may also be varied through the use of adjustment assemblies 140 and 142.

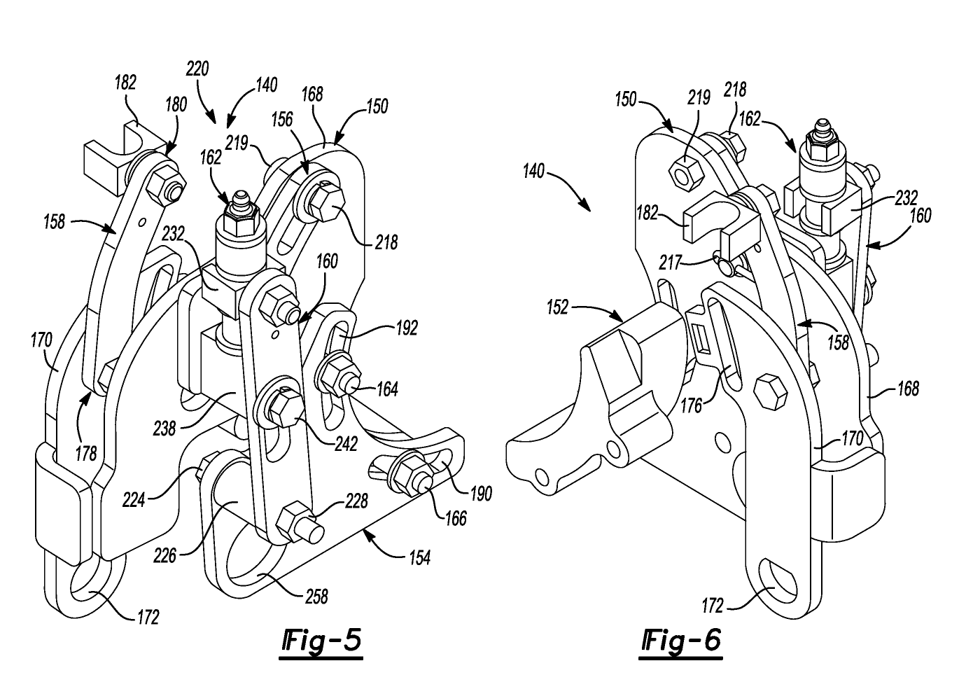

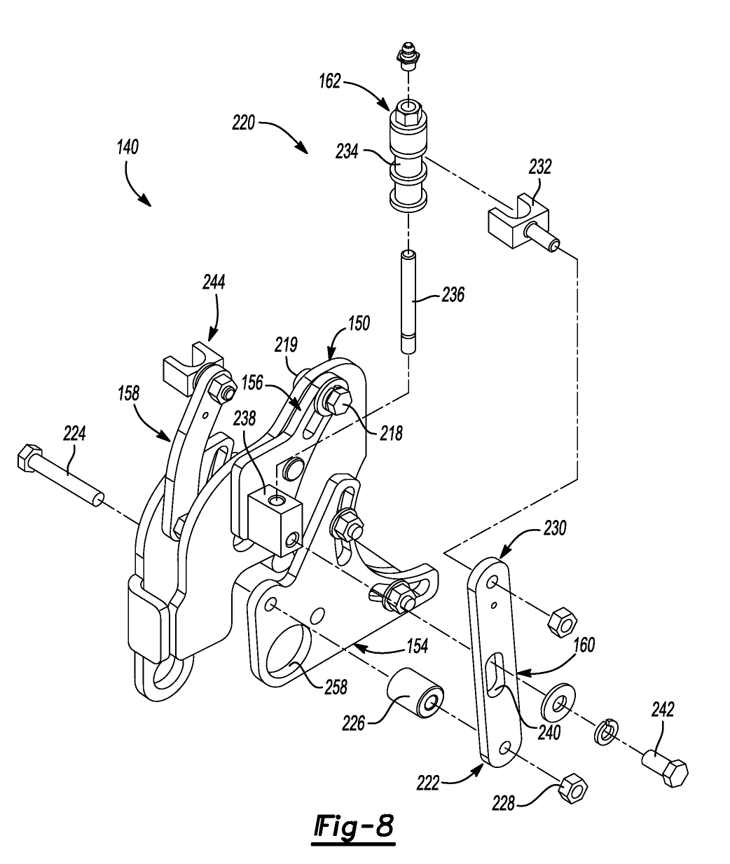

FIGS. 5 through 8 depict left front adjustment assembly 140 in greater detail. Left front adjustment assembly 140 is substantially the mirror image of right front adjustment assembly 142. Accordingly, only left front adjustment assembly 140 will be described. Adjustment assembly 140 includes a roller bracket 150, a spacer bracket 152, a groomer plate 154, a groomer adjustment bracket 156, a push plate 158, a link 160 and a groomer adjustment knob 162. Spacer bracket 152 is fixed to reel housing 100 to interconnect adjustment assembly 140 with left plate 110. A first stud 164 and a second stud 166 extend transversely from spacer bracket 152. First and second studs 164,166 are positioned along an arc extending about reel assembly axis of rotation 126.

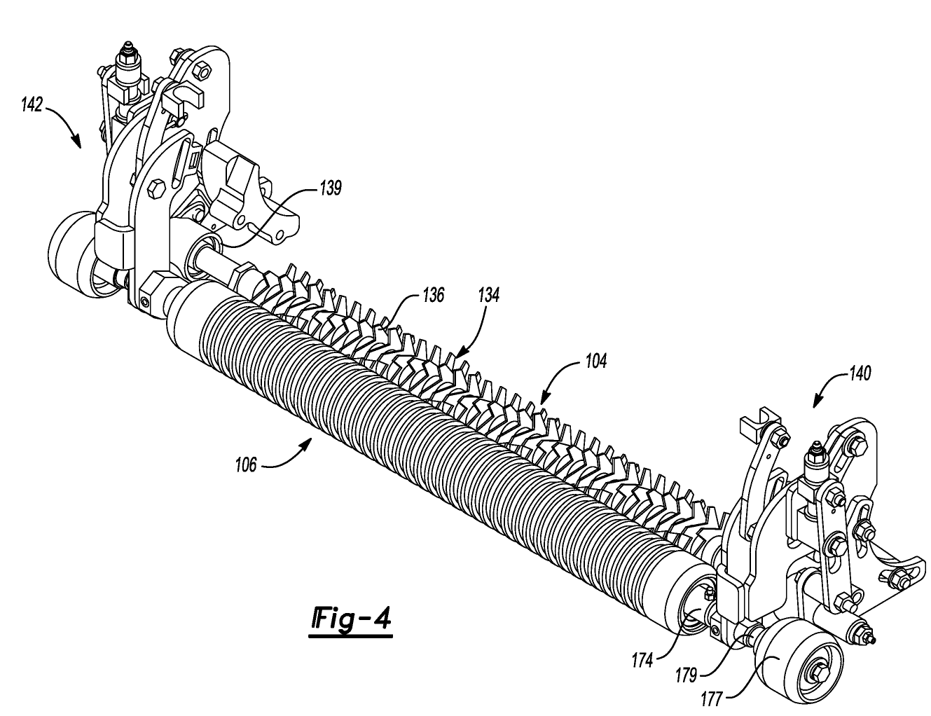

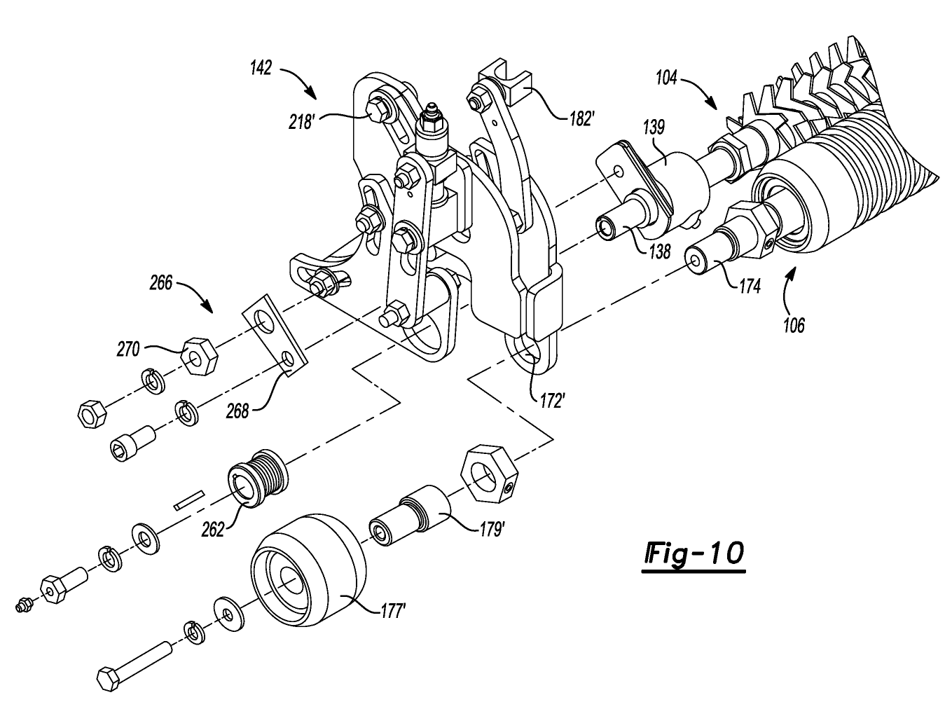

Roller bracket 150 includes an outboard plate 168 and an inboard plate 170 coupled to one another at their forward edges. Inboard plate 170 includes an aperture 172 in receipt of a front roller shaft 174 (FIG. 10) as well as a first slot 176. A guide roller 177 (FIG. 4) is rotatably supported on a stub shaft 179 coupled to roller bracket 150. Outboard plate 168 is spaced from and positioned substantially parallel to inboard plate 170. A gap formed between inboard plate 170 and outboard plate 168 is in receipt of push plate 158. Push plate 158 includes a first end 178 fixed to inboard plate 170 and a second end 180 having a yoke 182 fixed thereto.

Outboard plate 168 includes a third slot 184 and a fourth slot 186 extending along an arc drawn from reel assembly axis of rotation 126. In similar fashion, groomer plate 154 includes a fifth slot 190 and a sixth slot 192 extending at the same radius as third slot 184 and fourth slot 186. First stud 164 extends through fourth slot 186 and sixth slot 192. Second stud 166 extends through third slot 184 and fifth slot 190. It should be appreciated that first and second studs 164,166 are formed substantially similar to shoulder bolts having an enlarged shoulder 194 and a reduced diameter threaded portion 196. The outer diameter of shoulder portion 194 is sized to provide a slip fit between the slots formed in outboard plate 168. A first nut 198 is tightened to drive groomer plate 154 into contact with shoulder 194 of first stud 164. Similarly, a second nut 200 is tightened on second stud 166 to fix groomer plate 154 against shoulder 194 of second stud 166. At this time, spacer bracket 152 and groomer plate 154 may be rotated relative to roller bracket 150 about axis 126.

Groomer adjustment bracket 156 includes a seventh slot 210 and roller bracket 150 includes an eighth slot 212. A pin 214 extends through an aperture 216 formed in groomer adjustment bracket 156 and through eighth slot 212. Pin 214 is retained by a cotter pin 217. A threaded fastener 218 extends through seventh slot 210 and is secured in threaded engagement with a nut 219. Based on this arrangement, groomer adjustment bracket 156 is coupled to roller bracket 150 but remains free to rotate relative thereto.

A groomer position adjustment mechanism 220 includes link 160 having a first end 222 coupled to groomer plate 154 via a threaded fastener 224, a spacer 226 and a nut 228. A second opposite end 230 of link 160 is coupled to a yoke 232. Yoke 232 engages a land 234 formed on groomer adjustment knob 162. A stud 236 is threadingly engaged with a mounting block 238 fixed to groomer adjustment bracket 156. Groomer adjustment knob 162 is also threadingly engaged with stud 236 such that rotation of adjustment knob 162 axially displaces yoke 232. A ninth slot 240 is formed in link 160. A threaded fastener 242 extends through ninth slot 240 and is fixed to mounting block 238. Link 160 is allowed to move relative to block 238 to the extent possible based on the length of ninth slot 240.

A left hand reel cutting height adjustment mechanism 244 is best shown in FIG. 2. To best describe the cutting height mechanism, a right hand cutting height adjustment mechanism 244′ will be described. As previously mentioned, right front adjustment assembly 142 is substantially a mirror image of left front adjustment assembly 140. Accordingly, like elements of the right front adjustment assembly will include a prime suffix designation. Cutting height adjustment mechanism 244′ includes a block 246′ having a threaded rod 248′ extending therefrom. A cutting height adjustment knob 250′ includes a land 252′ engaged by yoke 182′. Rotation of adjustment knob 250′ axially displaces yoke 182′. Yoke 182′ is fixed to push plate 158′. Block 246′ is adjustably fixed to right plate 112 via a threaded fastener 254′. Fastener 254′ extends through a tenth slot 256′ formed in right plate 112 and first slot 176′ formed in roller bracket 150′.

To adjust the cutting height for reel assembly 54, fastener 254′ and its corresponding fastener 254 on the opposite side of cutting unit 26 are loosened. At this time, rotation of adjustment knobs 250, 250′ causes yokes 182, 182′ to translate such that reel housing 100 moves relative to adjustment assemblies 140 and 142. This relative movement also causes relative movement between reel assembly 54 and the ground. Once a desired cutting height is set, fastener 254′ and its counterpart 254 are tightened.

Adjustment assemblies 140, 142 are operable in a first mode to move the groomer between a first position where the cutting plates 134 engage the turf a predetermined amount and a second position where cutting plates 134 are spaced from the turf and further apart from reel blades 124. It may be desirable to place groomer 104 in the second position and operate mower assembly 10 to cut the turf and not simultaneously groom the turf. Alternatively, groomer 104 may be placed in the second position to provide access to sharpen the reel blades. Adjustment assemblies 140,142 are operable in a second mode to adjust the position of cutting plates 134 to vary the amount the cutting plates engage the turf when the groomer 104 is in the first position.

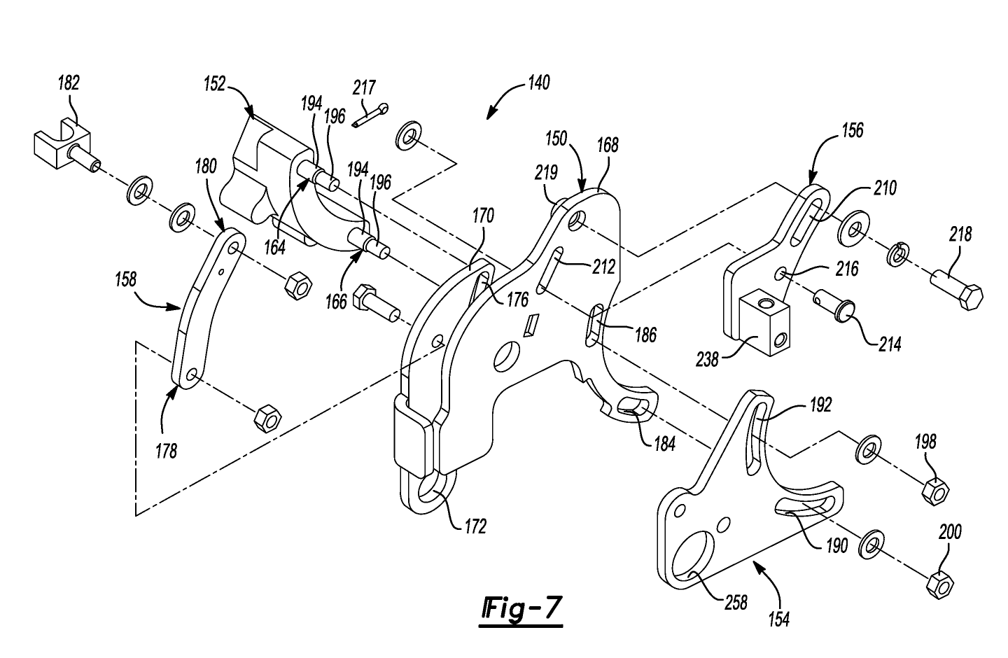

To adjust the depth of penetration of cutting plates 134 into the turf in the second mode of operation, an operator loosens fastener 242 and its corresponding fastener on right front adjustment assembly 142. Nuts 198 and 200 (FIG. 7) are also loosened to allow first stud 164 and second stud 166 to translate within fifth and sixth slots 190, 192. Groomer adjustment knob 162 is rotated until a desired grooming depth is reached. Once a desired groomer position is set, fastener 242 and its counterpart are tightened. First nut 198 and second nut 200 are also tightened at this time.

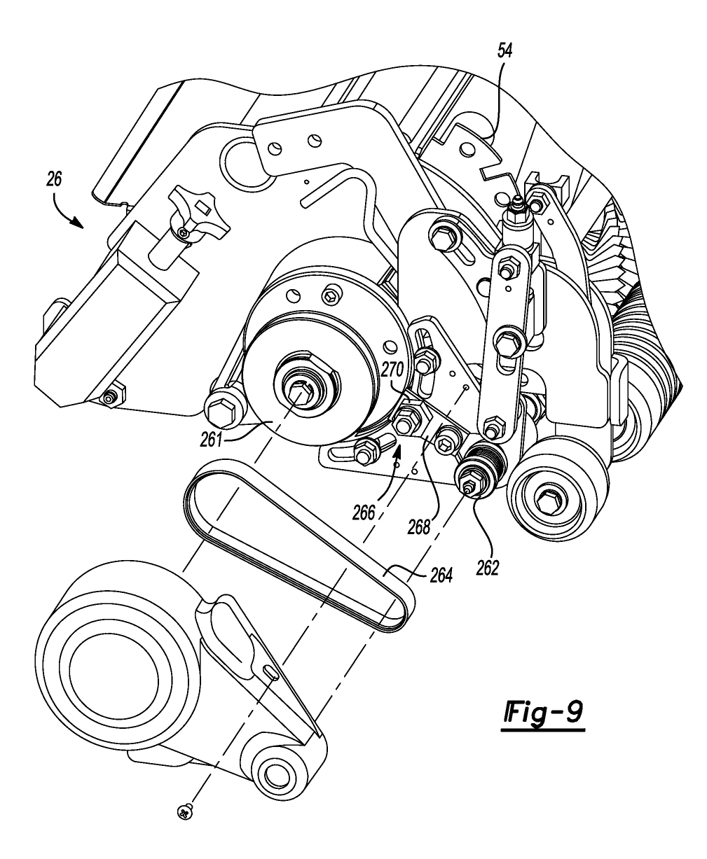

Groomer plate 154 includes an aperture 258 in receipt of driveshaft 138 of groomer 104. Driveshaft 138 may be driven from either end depending on a desired location of a power transmission path. FIGS. 9 and 10 depict a right hand drive assembly including a drive pulley 261 fixed to reel assembly 54 and a driven pulley 262 drivingly interconnected by a V-belt 264. A belt tensioning assembly 266 includes a tensioning bracket 268 and an eccentric cam 270. Rotation of cam 270 adjusts the tension on belt 264. Tensioning assembly 266, drive pulley 261, driven pulley 262 and V-belt 264 are configured to transfer a predetermined amount of torque to groomer driveshaft 138. If the groomer should possibly become incorrectly adjusted where a relatively deep cut is being attempted, V-belt 264 will slip on one of the pulley surfaces to prevent possible misuse of and damage to the cutting unit.

At times it may be desirable to sharpen reel blades 124 of reel assembly 54. To economically produce a balanced cutting arrangement, it may be desirable to sharpen reel blades 124 while mounted to reel housing 100. The position of groomer 104 shown in the drawings restricts access to reel blades 124. Accordingly, groomer 104 must be moved to provide a grinder or other sharpening-type machine access to reel blades 124. Previous methods of providing clearance for the blade sharpening equipment includes dissembling a large portion of cutting assembly 26 and removing groomer 104 from its rotatably mounted position previously described. After reel blades 124 have been sharpened, groomer 104 must be reinstalled and its cutting height must once again be adjusted as well. The removal, re-installation and height adjustment steps are time consuming.

The cutting unit of the present disclosure alleviates the need for the removal of groomer 104 during a blade sharpening process. To move groomer 104 from its previously adjusted position, adjustment assemblies 140, 142 are operated in the first mode of operation. A user may loosen fastener 218 on left front adjustment assembly 140 and the corresponding fastener 218′ on right front adjustment assembly 142. First nut 198 and second nut 200 are also loosened. At this time, groomer 104 may be rotated upwardly to a retracted position to allow access of sharpening tools to reel blades 124. Groomer 104 may be retained in the retracted position by tightening fasteners 218 and 218′. Upon completion of blade sharpening, groomer 104 may be rotated back to its previously adjusted position by simply loosening fasteners 218 and 218′ and allowing groomer adjustment bracket 156 to fully return to the position where fasteners 218 and 218′ are located at the upper edges of seventh slots 210 and 210′, respectively. At the same time, pins 214, 214′ slide within eighth slots 212, 212′ to engage their upper edges as well. The edges of the seventh slots 210, 210′ and eighth slots 212, 212′ act as stops limiting the movement of groomer adjustment bracket 156 relative to roller bracket 150 and provide a datum corresponding to the previously adjusted position of groomer 104. The previous groomer position is maintained by the interrelation between groomer adjustment knob 162, yoke 232, end 230, and groomer adjustment bracket 156. As previously discussed, it should be appreciated that the cutting unit may be operated with groomer 104 in the first or operating position shown in the drawings or alternatively in the second or retracted position when a grooming operation is not desired.

While the cutting units previously described are shown mounted on a riding mower, as mentioned above, it should be appreciated that the structures and inventive concepts presented may be applied to other mowers such as walk-behind mowers. Further, one skilled in the art will recognize that various other embodiments could include other grounds maintenance implements where it is generally desired to displace the implement to allow access to other structures of the assembly.

Furthermore, the foregoing discussion discloses and describes merely exemplary embodiments of the present disclosure. One skilled in the art will readily recognize from such discussion, and from the accompanying drawings and claims, that various changes, modifications and variations may be made therein without departing from the spirit and scope of the disclosure as defined in the following claims.

What is claimed is:

1. A turf cutting unit comprising:
a reel assembly including a plurality of blades rotatable relative to the ground;
a driven shaft; and
a groomer including a plurality of spaced apart and vertically oriented cutting plates fixed to the driven shaft, the groomer being moveable between a first position where the cutting plates engage the turf and a second position where the cutting plates are spaced apart from the turf.

2. The turf cutting unit of claim 1 further including an adjustment assembly operable to move the groomer and set a depth of penetration of the cutting plates into the turf at the first position.

3. The turf cutting unit of claim 2 wherein the set depth of penetration is maintained when the groomer is moved from the first position to the second position and back to the first position.

4. The turf cutting unit of claim 1 wherein the groomer is pivotally moveable between the first and second positions relative to a frame supporting the reel assembly.

5. The turf cutting unit of claim 1 wherein the groomer is moved to the second position to provide access to sharpen the reel blades.

6. The turf cutting unit of claim 5 wherein the groomer is positioned fore of the reel assembly to engage the turf prior to having the blades of the reel assembly cut the turf.

7. The turf cutting unit of claim 2 wherein the adjustment assembly includes a first plate fixed to the frame and having an arcuately shaped slot, the adjustment assembly also including a pin being selectively moveable within the slot to allow movement of the groomer between the first and second positions.

8. The turf cutting unit of claim 7 wherein the adjustment assembly includes a second plate having a slot and a second pin extending therethrough, the second pin being selectively moveable within the slot of the second plate to allow the groomer to rotate relative to the frame and set the depth of penetration at the first position.

9. The turf cutting unit of claim 8 wherein the adjustment assembly includes a moveable link interconnecting the first and second plates.

10. A turf cutting unit comprising:
a frame;
a reel assembly mounted to the frame and having a plurality of blades rotatable about a reel axis extending substantially parallel to the ground;
a driven shaft;
a groomer including a plurality of spaced apart and substantially vertically oriented cutting plates fixed to the driven shaft; and
a groomer adjustment mechanism being operable in a first mode to move the groomer between a first position where the cutting plates engage the turf a predetermined amount and a second position where the cutting plates are spaced apart from the turf, the groomer adjustment mechanism being operable in a second mode to adjust the position of the cutting plates to vary the amount the cutting plates engage the turf when the groomer is in the first position.

11. The turf cutting unit of claim 10 wherein the groomer adjustment mechanism includes a first member supporting the groomer and pivotally coupled to the frame, wherein relative movement between the first member and a second member occurs during the second mode of operation.

12. The turf cutting unit of claim 11 wherein the first member is a plate including an elongated slot extending along an arc.

13. The turf cutting unit of claim 12 wherein the arc has a center aligned with the reel axis.

14. The turf cutting unit of claim 11 wherein, during the first mode of operation the second member is selectively pivotally movable relative to a third member, and the first member is restricted from moving relative to the second member.

15. The turf cutting unit of claim 14 further including a pin extending through a slot in the second member, wherein the groomer is in the first position when the pin is positioned at an end of the second member slot.

16. A method of operating a turf cutting unit including a reel blade assembly and a groomer having cutting plates, the method comprising:
moving a first member relative to a second member to place the groomer at a first position and set a depth of penetration of the cutting plates;
restricting relative movement between the first and second members;
moving the first and second members as a unit relative to a third member to move the groomer from the first position to a second position clear of the turf;
returning the groomer to the first position by moving the first and second members relative to the third member; and
restricting the first and second members from movement relative to the third member to maintain the groomer at the first position.

17. The method of claim 16 further including engaging one of the first and second members with a stop to define the first position.

18. The method of claim 17 wherein moving the groomer to the second position includes pivoting the groomer relative to the reel blade assembly.

19. The method of claim 18 wherein moving the groomer to the second position includes translating a pin within a curved groove.

20. The method of claim 19 wherein setting the depth of penetration includes rotating a threaded member to translate a link and move the groomer relative to a frame supporting the reel blade assembly.

21. The method of claim 17 wherein returning the groomer to the first position includes engaging the stop without moving the first member relative to the second member.

22. A grounds maintenance assembly comprising:
a frame assembly;
a power unit connected to and supported by the frame, the power unit providing energy to enable operation of the grounds maintenance assembly; and
at least one grounds maintenance implement, the grounds maintenance implement being moveable between a first position where the grounds maintenance implement is in an operative position that conceals a second grounds maintenance implement and a second position where the grounds maintenance implement is spaced away from the first position to enable access to the second grounds maintenance implement.

23. The grounds maintenance assembly of claim 22 wherein the grounds maintenance assembly is one of a walking or riding assembly.

24. The grounds maintenance assembly of claim 22 wherein the grounds maintenance implement further comprises:
a reel assembly including a plurality of blades rotatable relative to the ground;
a driven shaft; and
a groomer including a plurality of spaced apart and vertically oriented cutting plates fixed to the driven shaft, the groomer being moveable between a first position where the cutting plates engage the turf and a second position where the cutting plates are spaced apart from the turf.

25. The grounds maintenance assembly of claim 24 wherein the grounds maintenance assembly is one of a walking or riding assembly.

26. The grounds maintenance assembly of claim 24 further including an adjustment assembly operable to move the groomer and set a depth of penetration of the cutting plates into the turf at the first position.

27. The grounds maintenance assembly of claim 26 wherein the set depth of penetration is maintained when the groomer is moved from the first position to the second position and back to the first position.

28. The grounds maintenance assembly of claim 22 wherein the groomer is pivotally moveable between the first and second positions relative to a frame supporting the reel assembly.

29. The grounds maintenance assembly of claim 22 wherein the reel assembly rotates about an axis extending substantially parallel to the driven shaft.

30. The grounds maintenance assembly of claim 29 wherein the groomer is positioned fore of the reel assembly to engage the turf prior to having the blades of the reel assembly cut the turf.

31. The grounds maintenance assembly of claim 25 wherein the adjustment assembly includes a first plate fixed to the frame and having an arcuately shaped slot, the adjustment assembly also including a pin being selectively moveable within the slot to allow movement of the groomer between the first and second positions.

32. The grounds maintenance assembly of claim 31 wherein the adjustment assembly includes a second plate having a slot and a second pin extending therethrough, the second pin being selectively moveable within the slot of the second plate to allow the groomer to rotate relative to the frame and set the depth of penetration at the first position.

33. The turf cutting unit of claim 32 wherein the adjustment assembly includes a moveable link interconnecting the first and second plates.
